(19) United States
(12) Patent Application Publication
(10) Pub. No.: US 2026/0017531 A1
(43) Pub. Date: Jan. 15, 2026

(54) FOCAL LEARNING-BASED METHOD FOR INTELLIGENT CT ANGIOGRAPHY IMAGING

(71) Applicant: THE FIRST MEDICAL CENTER OF PLA GENERAL HOSPITAL, Beijing (CN)

(72) Inventors: Xin LOU, Beijing (CN); Mingliang YANG, Beijing (CN); Jinhao LYU, Beijing (CN)

(73) Assignee: THE FIRST MEDICAL CENTER OF PLA GENERAL HOSPITAL, Beijing (CN)

(21) Appl. No.: 19/330,527

(22) Filed: Sep. 16, 2025

Related U.S. Application Data
(63) Continuation of application No. PCT/CN2023/109843, filed on Jul. 28, 2023.

(30) Foreign Application Priority Data
Sep. 26, 2022 (CN) 202211178939.8

(51) Int. Cl. G06N 3/094; G06N 3/0464; G06N 3/0475; G06T 7/00

(52) U.S. Cl. CPC G06N 3/094; G06N 3/0464; G06N 3/0475; G06T 7/0012; G06T 2207/10081; G06T 2207/20081

(57) ABSTRACT

The present invention discloses a focal learning-based method for intelligent CT angiography imaging. (1) Acquiring NCCT images and their corresponding real CTA images; (2) Constructing an adversarial network model comprising a generator, a corrector, and a discriminator; (3) Formulating a joint focal learning loss function for the generator-corrector pair and a separate loss function for the discriminator; (4) Training the adversarial network model using the training set, and validating the trained model using the validation set; (5) Identifying the generator with the best test performance by virtue to the test set. The invention establishes a joint focal learning loss function, which allows the generator to create synthetic CTA images that more effectively emphasize target areas, like vascular tissues. Furthermore, a corrector is incorporated into the invention to facilitate improved registration and alignment between NCCT images and CTA images.

### CROSS-REFERENCE TO RELATED APPLICATIONS

The application claims priority to Chinese patent application No. 202211178939.8, filed on Sep. 26, 2022, the entire contents of which are incorporated herein by reference.

### TECHNICAL FIELD

This invention relates to the field of artificial intelligence, particularly to a focal learning-based method for intelligent CT angiography imaging.

### BACKGROUND

CT angiography (CTA) involves the use of contrast agents, which necessitates multiple returns of CT scanning and thereby incurs substantial time and costs. To address these issues, artificial intelligence technologies are proposed to be employed. Specifically, a focal learning-based adversarial network model can be constructed to facilitate the image conversion from non-contrast CT (NCCT) to CTA. This approach aims to streamline the CTA examination procedure and provide a faster and more cost-effective imaging option.

In recent years, with the development of artificial intelligence technology, image-to-image conversion models such as the Pix2pix network [Isola P, et al. Proceedings of the IEEE Conference on Computer Vision and Pattern Recognition. 2017: 1125-1134.] have emerged, achieving more effective modality conversion between paired images. However, in practical applications, it is often difficult to obtain a large number of high-quality paired medical images. To address this issue, researchers have attempted to apply the cycleGAN model [Zhu J Y, et al. Proceedings of the IEEE International Conference on Computer Vision. 2017: 2223-2232.] to unpaired medical image modality conversion. Nevertheless, the results obtained have been limited. In response to the challenges of obtaining strictly paired medical images and the limited effectiveness of unsupervised learning with unpaired data, recent advancements have introduced medical image modality conversion models such as RegGAN [Kong L, et al. Advances in Neural Information Processing Systems, 2021, 34:1964-1978.]. However, current models fail to account for the varying importance of different tissue regions. As a result, models trained under these conditions are unable to highlight the image data of critical regions.

### SUMMARY

To address the aforementioned technical challenges, the present invention provides a focal learning-based method for intelligent CT angiography imaging, which employs the following technical solutions:

A focal learning-based method for intelligent CT angiography imaging, comprising the following steps:
Step 1: Acquiring NCCT images and their corresponding real CTA images, followed by normalization processing. The normalized NCCT images and the corresponding normalized real CTA images constitute sample pairs, which are subsequently partitioned into training, validation, and test sets;
Step 2: Constructing an adversarial network model that comprises a generator, a corrector, and a discriminator;
Step 3: Formulating a joint focal learning loss function for the generator-corrector pair and a separate loss function for the discriminator;
Step 4: Training the adversarial network model using the training set and validating the trained model using the validation set;
Step 5: Inputting sample pairs from the test set into the generator to produce normalized synthetic CTA images, and testing and evaluating the obtained images to identify the generator with the best test performance;
Step 6: Loading the best-performing generator produced in Step 5 and inputting the normalized NCCT images to be processed into the generator, which outputs the corresponding normalized synthetic CTA images.

The above-mentioned generator comprises an input layer, an encoder, a central residual module, a decoder, and an output layer. The following steps are taken in the generator:

The normalized NCCT image is input into the input layer;
The encoder consists of multiple downsampling convolutional layers;
The central residual module comprises several residual blocks;
The decoder includes multiple upsampling convolutional layers;
Apart from the output layer, normalization and activation functions are applied in the input layer, downsampling convolutional layers, residual blocks, and upsampling convolutional layers. The output layer performs a 2D convolution operation on the output from the upsampling convolutional layers and outputs a normalized synthetic CTA image through an activation function.

The above-mentioned corrector comprises an encoder, a central residual module, a decoder, and an output end. The output end includes a refinement module and an output layer. The following steps are taken in the corrector:
The normalized synthetic CTA image generated by the generator and the normalized real CTA image are input into the encoder;
The encoder consists of multiple downsampling convolutional layers;
The central residual module comprises several residual blocks;
The decoder includes multiple upsampling convolutional layers;
The refinement module consists of residual blocks and convolutional layers;
The downsampling convolutional layers of the encoder are connected to the corresponding upsampling convolutional layers of the decoder via skip connections;
Normalization and activation functions are applied to the downsampling convolutional layers of the encoder, the residual blocks of the central residual module, and the upsampling convolutional layers of the decoder, except for the refinement module at the output end and the output layer. The output layer generates the correction space matrix.

The above-mentioned discriminator comprises multiple downsampling convolutional layers and a 2D convolution output layer. The inputs to the discriminator are either normalized real CTA images or normalized synthetic CTA images. The discriminator outputs a single-channel image matrix block, which, after undergoing average pooling, yields the corresponding pooling value.

The joint focal learning loss function L_{GR} for the generator-corrector pair, as stated in the above Step 3, is defined by the following formula:

$$\begin{matrix}min {L}_{G R} = {L}_{G A N} ( G , D ) + {\sum }_{i = 1}^{m} {b}_{i} {L}_{C o r r}^{i} + γ {L}_{Smooth} \\ {L}_{G A N} ( G , D ) = {E}_{x} [ {( 1 - D ( G ( x ) ) )}^{2} ] \\ {L}_{C o r r}^{i} = {E}_{x , y} [ {‖ {y}^{i} - {( G ( x ) ° R ( G ( x ) , y ) )}^{i} ‖}_{1} ] \\ {L}_{Smooth} = {E}_{x , y} [ {‖ ∇ R ( G ( x ) , y ) ‖}_{1}^{2} ]\end{matrix}$$

Where, L_{GAN}(G, D) denotes the adversarial loss function, where D is the discriminator and G is the generator; m represents the number of focal scales; bᵢ is the weighting coefficient for the

$${i}^{t h} {L}_{C orr}^{i} ; {L}_{C orr}^{i}$$

represents the correction loss function; γ is the weighting coefficient for L_{Smooth}; L_{Smooth} is the smoothing loss function; E(⋅) is the expectation operator, with the subscript indicating the input variable; x is the normalized NCCT image input to the generator G; y is the normalized real CTA image; ° represents the resampling operation; R is the corrector; ∇ is the gradient operator; ∥⋅∥₁ is L₁ distance operator.

The discriminator's loss function L_{Adv}(G, D) stated the above Step 3 is defined by the following formula:

$$min {L}_{A d v} ( G , D ) = {E}_{y} [ {( 1 - D ( y ) )}^{2} ] + {E}_{x} [ {D ( G ( x ) )}^{2} ] .$$

The specific steps for training the adversarial network model in the above Step 4 are as follows:
Firstly, the parameters of the discriminator are kept constant, and the minimum value of the joint focal learning loss function L_{GR} is computed to update the parameters of the generator and the corrector;
Secondly, the parameters of the generator and the corrector are kept constant, and the minimum value of the discriminator's loss function L_{Adv}(G, D) is computed to optimize and update the discriminator parameters.

The test performance in the above Step 5 includes the Mean Absolute Error (MAE) and Peak Signal-to-Noise Ratio (PSNR) of the normalized synthetic CTA image, as well as the Structural Similarity Index Measure (SSIM) between the normalized synthetic CTA image and the normalized real CTA image.

Compared to the existing technologies, the present invention has the following advantageous effects:

1. The present invention provides a focal learning-based method for intelligent CT angiography imaging, reducing the necessity of using contrast agents.

2. The present invention constructs a joint focal learning loss function for the generator-corrector pair, enabling the generator to produce CTA images that better highlight vascular tissues.

3. The present invention introduces a corrector, which enables better registration and alignment between NCCT images and CTA images, thereby establishing a more accurate mapping relationship between them and improving the quality of synthesized CTA images.

4. The present invention possesses good robustness and scalability, facilitating modular integration and distributed deployment.

### BRIEF DESCRIPTION OF DRAWINGS

FIG. 1 illustrates the network architecture of the adversarial network model of the present invention;

FIG. 2 depicts the network architecture of the generator G of the present invention;

FIG. 3 illustrates the network architecture of the corrector R of the present invention;

FIG. 4 depicts the network architecture of the discriminator D of the present invention.

### DETAILED DESCRIPTION OF THE EMBODIMENTS

To facilitate understanding and implementation of the present invention by ordinary technicians in the field, the following detailed description is provided regarding the specific examples. The embodiment described herein is only intended to illustrate and explain the invention and is not intended to limit the scope of the invention.

### Embodiment 1

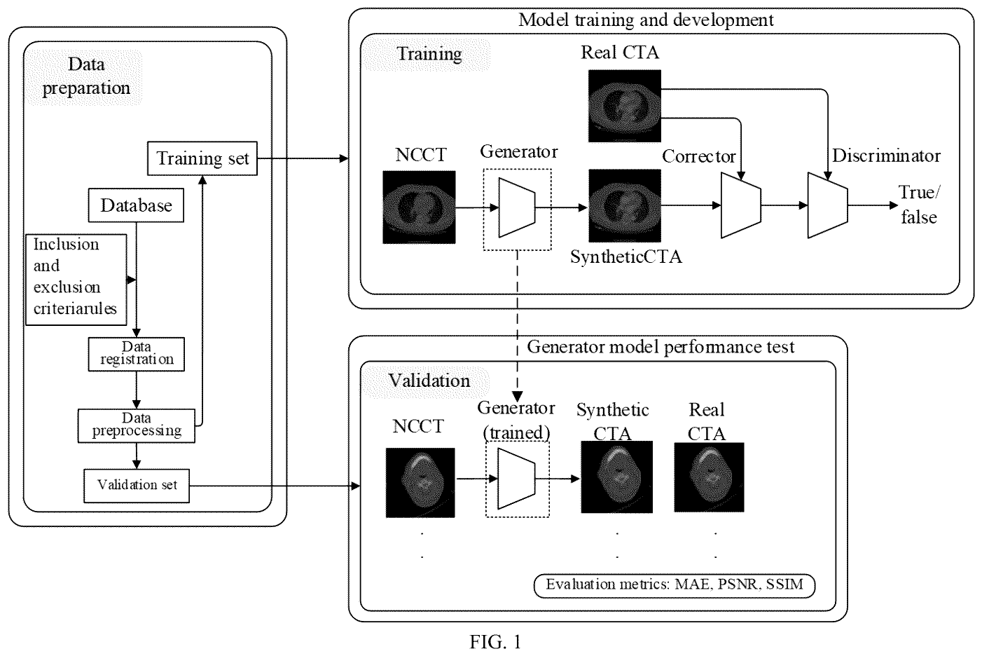

As shown in FIG. 1, the focal learning-based method for intelligent CT angiography imaging includes the following steps:
Step 1: Acquiring NCCT images and their corresponding real CTA images, and subjecting them to quality inspection and normalization in sequence. The normalized NCCT images and the corresponding normalized real CTA images constitute sample pairs, which are subsequently partitioned into training, validation, and test sets:
The quality inspection criteria follow one or more of the following inclusion and exclusion rules: (1) The scanning interval between the NCCT images and the corresponding real CTA images does not exceed 1 month; (2) The slice thickness and number of slices are consistent between the NCCT images and the corresponding real CTA images, and the slices correspond to each other; (3) The NCCT images and the corresponding real CTA images are regularly stored; (4) There are no severe artifacts in the NCCT images or the real CTA images; (5) The NCCT images and the real CTA images are normally scanned with adequate imaging filling; (6) The arteries have not undergone any surgeries, such as aneurysm surgery;
The original grayscale space [−1024 3071] of the NCCT images and their corresponding real CTA images are normalized to the range [−1 1] to accelerate the convergence of model training;
The normalized NCCT images and their corresponding real CTA images are used as sample pairs. These sample pairs are randomly divided into training, validation, and test sets in a ratio of 6:1:3 for model training, validation, and test.

Step 2: Constructing an adversarial network model based on the theory of nonlinear combinations, and using convolutional networks to build a generator, a corrector, and a discriminator, respectively.

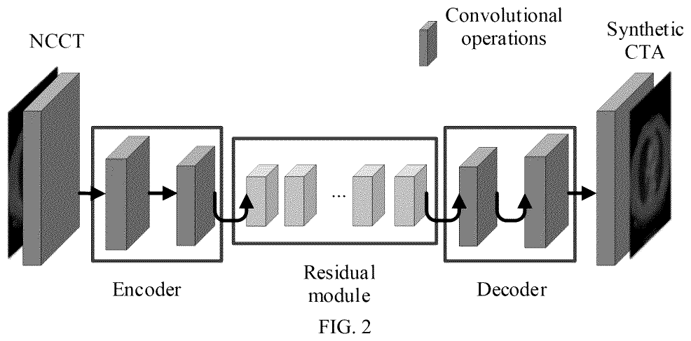

Step 2.1: Constructing a generator. The framework of the generator model in this embodiment is shown in FIG. 2. The generator structure includes an input layer, an encoder, a central residual module, a decoder, and an output layer in sequence. Specifically, the encoder consists of 2 downsampling convolutional layers, the central residual module includes 9 residual blocks, and the decoder consists of 2 upsampling convolutional layers.

The input layer has channel numbers of 1->64. The encoder's two downsampling convolutional layers have channel numbers of 64->128 and 128->256, respectively. Each residual block in the central residual module has 256 channels. The decoder's two upsampling convolutional layers have channel numbers of 256->128 and 128->64, respectively. The output layer has channel numbers of 64->1. The convolutional kernels of the generator's input and output layers are 7×7 with a convolutional stride size of 1 and padding of 3. The convolutional kernels of the encoder and decoder are both 3×3 with a convolutional stride size of 2 and padding of 1. Each residual block in the central residual module has a convolutional kernel of 3×3, with a convolutional stride size of 1 and padding of 1. Except for the output layer, the input layer, downsampling convolutional layers, residual blocks, and upsampling convolutional layers all employ instancenormal2d normalization and ReLU activation functions. The final output layer performs a 2D convolution operation on the output from the upsampling convolutional layers and outputs the normalized synthetic CTA image via the tanh activation function.

The dimensions of both the input and output layers are sample batch size×number of image channels×image width×image height. In this embodiment, the sample batch size for each training step is 1. The number of image channels input into the input layer and the number of image channels from the output layer are both 1. The image width and height are both 512. The input layer receives normalized NCCT images, and the output layer produces normalized synthetic CTA images.

The encoder is designed to encode the input normalized NCCT image into deep features. The central residual module performs multiple convolutional operations on the encoded deep features to obtain features that are more representative of the target image. The decoder then decodes the features output by the central residual module into the target image.

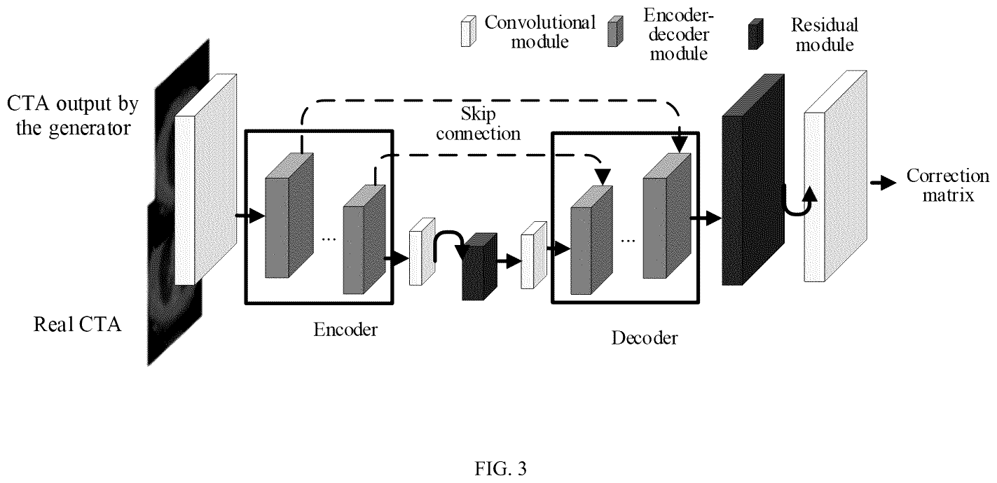

Step 2.2: Constructing the corrector. The framework of the corrector model in this embodiment is shown in FIG. 3. The main body of the corrector network includes an encoder, a central residual module, a decoder, and an output end, which consists of a refinement module and an output layer. The inputs to the corrector are the normalized synthetic CTA images generated by the generator and the normalized real CTA images. The outputs of the corrector are the correction space matrix between the normalized synthetic CTA images and the normalized real CTA images.

The encoder consists of multiple downsampling convolutional layers, and the decoder consists of multiple upsampling convolutional layers. The number of downsampling convolutional layers in the encoder is equal to that of upsampling convolutional layers in the decoder. The downsampling convolutional layers of the encoder are connected to the corresponding upsampling convolutional layers of the decoder via skip connections. In this embodiment, the encoder comprises 7 downsampling convolutional layers; the central residual module includes 3 residual blocks; the decoder consists of 7 upsampling convolutional layers; the refinement module includes 1 residual block and 1 convolutional layer. The central residual module is respectively preceded and followed by a convolutional layer with a kernel size of 1×1, a convolutional stride size of 1, and no padding. For the downsampling convolutional layer, the residual blocks within the central residual module, the upsampling convolutional layer, and the residual blocks within the refinement module all have a 3×3 convolutional kernel, with a convolutional stride size of 1 and padding of 1, and the activation function used is LeakyReLU. Within the refinement module, the convolutional layers have a convolutional kernel of 1×1, a convolutional stride size of 1, and padding of 0. The output layer features a convolutional kernel of 3×3, a convolutional stride size of 1, and padding of 1, with no activation function applied.

As shown in FIG. 3, due to the skip connections between the downsampling convolutional layers of the encoder and the corresponding upsampling convolutional layers of the decoder, the inputs to each upsampling convolutional layer in the decoder come from two sources: the output of the upper level and the output of the downsampling convolutional layer in the encoder corresponding to the upsampling convolutional layer at the current level. Therefore, the input channels to the upsampling convolutional layers in the decoder are in the form of c1+c2: c1 represents the number of output channels from the upper level. For example, the c1 value corresponding to the upsampling convolutional layer of the 1^{st} level decoder is the number of channels output from the convolutional layer after the central residual module. The c1 value corresponding to the upsampling convolutional layer of the 2^{nd} level decoder is the number of channels output from the upsampling convolutional layer of the 1^{st} level decoder, and so on. c2 is the number of output channels from the downsampling convolutional layer of the encoder corresponding to the upsampling convolutional layer of the current level decoder. The number of channels output from the decoder's upsampling convolutional layer is the same as the number of channels output from the downsampling convolutional layer of the encoder corresponding to the current level's upsampling convolutional layer.

In this embodiment, the encoder's 7 downsampling convolutional layers have channel numbers changing sequentially as follows: 2->32, 32->64, 64->64, 64->64, 64->64, 64->64, and 64->64. The inputs to the encoder are normalized synthetic CTA images generated by the generator and normalized real CTA images; hence, the input channel number of the first-level downsampling convolutional layer is 2. The convolutional layer preceding the central residual module has a channel number change of 64->128, each residual block within the central residual module has 128 channels, and the convolutional layer following the central residual module has a channel number change of 128->64. The decoder's 7 upsampling convolutional layers have channel numbers changing sequentially as follows: 64+64->64, 64+64->64, 64+64->64, 64+64->64, 64+64->64, 64+64->64, and 64+32->32. The refinement module has 32 channels. The output layer has a channel number change of 32->2. Except for the refinement module at the output end and the output layer, the downsampling convolutional layers of the encoder, the residual blocks of the central residual module, and the upsampling convolutional layers of the decoder all employ instancenormal2d normalization and LeakyReLU activation functions. The correction space matrix is ultimately output by the output layer.

The dimension of the correction space matrix output in this embodiment is [batch size, number of output layer channel, image width, image height], i.e., [1,2,512,512].

Step 2.3: Constructing a discriminator that is used to determine whether a given image is a normalized real CTA image.

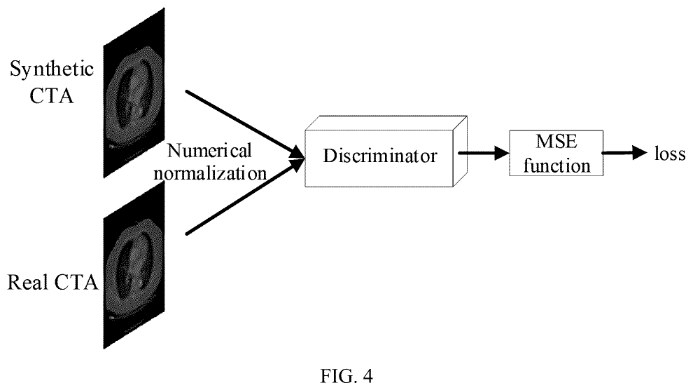

As depicted in FIG. 4, the discriminator model framework of this embodiment includes four downsampling convolutional layers and one 2D convolutional output layer. Each downsampling convolutional layer employs the LeakyReLU activation function and instancenormal2d normalization. All convolutional operations within the discriminator utilize a 4×4 convolutional kernel. The first three downsampling convolutional layers have a stride size of 2 and padding of 1, whereas the fourth downsampling layer and the output convolutional layer have a stride size of 1 and padding of 1. Inputs to the discriminator are either normalized real CTA images or normalized synthetic CTA images. After undergoing multiple convolutional operations in the discriminator, a single-channel image matrix block with dimensions of 62×62 is produced. This matrix block is subsequently subjected to average pooling (the pooling layer) using the avg pool2d function of torch, yielding the corresponding pooling value.

Step 3: Formulating a joint focal learning loss function for the generator-corrector pair and a separate loss function for the discriminator based on the design of the proposed adversarial network model. By way of the focal design on the correction loss, it is ensured that the joint learning of the generator and the corrector is directed towards the target region.

The joint focal learning loss function L_{GR}for the generator-corrector pair is defined by the following formula:

$$\begin{matrix}min {L}_{G R} = {L}_{G A N} ( G , D ) + {\sum }_{i = 1}^{m} {b}_{i} {L}_{C o r r}^{i} + γ {L}_{Smooth} \\ {L}_{G A N} ( G , D ) = {E}_{x} [ {( 1 - D ( G ( x ) ) )}^{2} ] \\ {L}_{C o r r}^{i} = {E}_{x , y} [ {‖ {y}^{i} - {( G ( x ) ° R ( G ( x ) , y ) )}^{i} ‖}_{1} ] \\ {L}_{Smooth} = {E}_{x , y} [ {‖ ∇ R ( G ( x ) , y ) ‖}_{1}^{2} ]\end{matrix}$$

Where,

L_{GAN}(G, D) denotes the adversarial loss function; D is the discriminator; G is the generator; m represents the number of focal scales and equals 2 (m=2) in this embodiment; bᵢ is the weighting coefficient for the i^{th}

$${L}_{C orr}^{i}$$

and equals 20 (b₁=20, b₂=2) in this embodiment;

$${L}_{C orr}^{i}$$

represents the correction loss function with different values of i corresponding to different focus regions. In this embodiment, i is set to 1 and 2. For i=1, the full-image loss between y and G(x)°R(G(x),y) is computed. For i=2, the regional filtered image loss between y and G(x)°R(G(x),y) is computed; the region where the normalized image HU values in the default window of the DICOM file of the real CTA image are greater than the threshold of 0.65 is defined as the filtered region, and the corresponding image is defined as the regional filtered image; γ is the weighting coefficient for L_{Smooth}; L_{Smooth} is the smoothing loss function; E(⋅) is the expectation operator, with the subscript indicating the input variable; x is the normalized NCCT image input to the generator G; G(x) is the output of the generator, namely the normalized synthetic CTA image; y is the normalized real CTA image; ° corresponds to the grid_sample( ) resampling operation in the torch library; R is the corrector; R(G(x),y) represents the correction space matrix output by the corrector during training, which is used to correct G(x) output by the generator and as a result, produce G(x)°R(G(x),y) (i.e., the normalized synthetic CTA image after correction); ∇ is the gradient operator; ∥⋅∥₁ is L₁ distance operator.

The discriminator's loss function L_{Adv}(G, D) is defined by the following formula:

$$min {L}_{A d v} ( G , D ) = {E}_{y} [ {( 1 - D ( y ) )}^{2} ] + {E}_{x} [ {D ( G ( x ) )}^{2} ] .$$

The symbols have the same meanings as in the loss functions of the generator and the corrector.

Step 4: Training the adversarial network model using the training set and validating the intermediate training models using the validation set. The specific steps are as follows:

Firstly, the parameters of the discriminator are held constant. The minimum value of the joint focal learning loss function L_{GR} is computed using the normalized synthetic CTA image, the normalized synthetic CTA image after correction, and the normalized real CTA image. This step results in the updating of the generator and corrector parameters.

Subsequently, the parameters of the generator and the corrector are maintained constant. The normalized synthetic CTA image and the normalized real CTA image are input into the well-constructed discriminator to calculate the minimum value of the discriminator's loss function L_{Adv}(G, D). The parameters of the discriminator are optimized and updated based on the calculated loss value.

Lastly, the validation set data is used to validate and test the intermediate model, having undergone training updates, to evaluate the correctness and effectiveness of the model's iterative updates.

The experimental platform in this embodiment is a Linux system server with an NVIDIA GeForce RTX3090Ti GPU and 64 GB of memory, using Python version 3.8.

PyTorch is chosen as the deep learning framework for model construction. The optimizer is Adam, and the initial learning rates for the generator, the corrector, and the discriminator are all 0.0001, with no learning rate decay strategy applied. The total number of model iterations (epochs) is set to 80 (epoch=80).

### Step 5: Model Testing

The generator of the adversarial network model obtained in Step 4 is tested and evaluated using the test set. Normalized NCCT images are input into the generator of the adversarial network model obtained in Step 4, in order to generate normalized synthetic CTA images. These synthetic images are compared with the normalized real CTA images for evaluation. The model with the best test performance is selected as the final model for application.

The performance test metrics include the Mean Absolute Error (MAE) and Peak Signal-to-Noise Ratio (PSNR) of the normalized synthetic CTA images, as well as the Structural Similarity Index (SSIM) between the normalized synthetic CTA images and the normalized real CTA images.

### Step 6: Model Application

Loading the generator obtained in Step 5, and inputting the normalized NCCT images to be processed into the generator which will output normalized synthetic CTA images.

The [−1 1] normalized synthetic CTA images output by the generator are converted back to the original grayscale space ([−1024 3071]) through inverse normalization to obtain the synthetic images in the original grayscale space.

The synthetic images in the original grayscale space are transformed into binary format and assigned to the PixelData in the DICOM header file, while other DICOM header file information is kept consistent with the NCCT image header file. This process yields synthetic CTA images.

A CT angiography imaging device based on focal learning consists of six modules: module 1, module 2, module 3, module 4, module 5, and module 6. Steps 1 to 6 described above are realized by the modules 1 to 6, respectively.

The present invention is not limited to the above-mentioned way of embodiment, which is merely a preferred example of this invention and does not restrict the scope of this invention. The implementation scheme in the above embodiment can be further combined or substituted. All variations and improvements made by those skilled in the field to the technical solutions of this invention fall within the scope of protection of this invention.

What is claimed is:

1. A focal learning-based method for intelligent CT angiography imaging, comprising the following steps:
Step 1: Acquiring NCCT images and their corresponding real CTA images, followed by normalization processing; The normalized NCCT images and the corresponding normalized real CTA images constitute sample pairs, which are subsequently partitioned into training, validation, and test sets;
Step 2: Constructing an adversarial network model comprising a generator, a corrector, and a discriminator;
Step 3: Formulating a joint focal learning loss function for the generator-corrector pair and a separate loss function for the discriminator;
Step 4: Training the adversarial network model using the training set, and validating the trained model using the validation set;
Step 5: Inputting sample pairs from the test set into the generator to produce normalized synthetic CTA images, and testing and evaluating the obtained images to identify the generator with the best test performance;
Step 6: Loading the best-performing generator produced in Step 5 and inputting the normalized NCCT images to be processed into the generator, which outputs the corresponding normalized synthetic CTA images;
The joint focal learning loss function L_{GR} for the generator-corrector pair, as stated in Step 3, is defined by the following formula:
$$\begin{matrix}min {L}_{G R} = {L}_{G A N} ( G , D ) + {\sum }_{i = 1}^{m} {b}_{i} {L}_{C o r r}^{i} + γ {L}_{Smooth} \\ {L}_{G A N} ( G , D ) = {E}_{x} [ {( 1 - D ( G ( x ) ) )}^{2} ] \\ {L}_{C o r r}^{i} = {E}_{x , y} [ {‖ {y}^{i} - {( G ( x ) ° R ( G ( x ) , y ) )}^{i} ‖}_{1} ] \\ {L}_{Smooth} = {E}_{x , y} [ {‖ ∇ R ( G ( x ) , y ) ‖}_{1}^{2} ]\end{matrix}$$
Where, L_{GAN}(G, D) denotes the adversarial loss function, where D is the discriminator and G is the generator; m represents the number of focal scales; bᵢ is the weighting coefficient for the
$${i}^{t h} {L}_{C orr}^{i} ; {L}_{C orr}^{i}$$
represents the correction loss function; γ is the weighting coefficient of L_{Smooth}; L_{Smooth} is the smoothing loss function; E(⋅) is the expectation operator, with the subscript indicating the input variable; x is the normalized NCCT image input to the generator G; ° represents the resampling operation; R is the corrector; ∇ represents the gradient operator; ∥⋅∥₁ is L₁ distance operator; R(G(x),y) denotes the correction space matrix output by the corrector through training; G(x) is the output of the generator; G(x)°R(G(x),y) is the normalized synthetic CTA image after correction; y is the normalized real CTA image; i takes values 1 and 2; when i=1, the full-image loss between y and G(x)°R(G(x),y) is computed; when i=2, the region-filtered image loss between y and G(x)°R(G(x),y) is computed;
The discriminator's loss function L_{Adv}(G, D) stated in Step 3 is defined by the following formula:
$$min {L}_{A d v} ( G , D ) = {E}_{y} [ {( 1 - D ( y ) )}^{2} ] + {E}_{x} [ {D ( G ( x ) )}^{2} ] .$$

2. Regarding the focal learning-based method for intelligent CT angiography imaging as described in claim 1, the generator concerned comprises an input layer, an encoder, a central residual module, a decoder, and an output layer; The following steps are taken in the generator:
A normalized NCCT image is input into the input layer;
The encoder consists of multiple downsampling convolutional layers;
The central residual module comprises several residual blocks;
The decoder includes multiple upsampling convolutional layers;
Apart from the output layer, normalization and activation functions are applied in the input layer, downsampling convolutional layers, residual blocks, and upsampling convolutional layers; The output layer performs a 2D convolution operation on the output from the upsampling convolutional layers and outputs a normalized synthetic CTA image through an activation function.

3. In terms of the focal learning-based method for intelligent CT angiography imaging as described in claim 2, the corrector comprises an encoder, a central residual module, a decoder, and an output end; The output end includes a refinement module and an output layer; The following steps are taken in the corrector:
The normalized synthetic CTA image generated by the generator and the normalized real CTA image are input into the encoder;
The encoder consists of multiple downsampling convolutional layers;
The central residual module comprises several residual blocks;
The decoder includes multiple upsampling convolutional layers;
The refinement module consists of residual blocks and convolutional layers;
The downsampling convolutional layers of the encoder are connected to the corresponding upsampling convolutional layers of the decoder via skip connections;
Normalization and activation functions are applied to the downsampling convolutional layers of the encoder, the residual blocks of the central residual module, and the upsampling convolutional layers of the decoder, except for the refinement module at the output end and the output layer; The output layer generates the correction space matrix.

4. In terms of the focal learning-based method for intelligent CT angiography imaging as described in claim 3, the discriminator comprises multiple downsampling convolutional layers and a 2D convolution output layer; The inputs to the discriminator are either normalized real CTA images or normalized synthetic CTA images; The discriminator outputs a single-channel image matrix block, which, after undergoing average pooling, yields the corresponding pooling value.

5. In terms of the focal learning-based method for intelligent CT angiography imaging as described in claim 1, the specific steps for training the adversarial network model in Step 4 are as follows:
Firstly, the parameters of the discriminator are kept constant, and the minimum value of the joint focal learning loss function L_{GR}is computed to update the parameters of the generator and the corrector;
Secondly, the parameters of the generator and the corrector are kept constant, and the minimum value of the discriminator's loss function L_{Adv}(G, D) is computed to optimize and update the discriminator parameters.

6. In terms of the focal learning-based method for intelligent CT angiography imaging as described in claim 1, the test performance in Step 5 includes the Mean Absolute Error (MAE) and Peak Signal-to-Noise Ratio (PSNR) of the normalized synthetic CTA image, as well as the Structural Similarity Index Measure (SSIM) between the normalized synthetic CTA image and the normalized real CTA image.
